(19) United States
(12) Patent Application Publication
(10) Pub. No.: US 2004/0013270 A1
(43) Pub. Date: Jan. 22, 2004

(54) Apparatus and method for converting contents

(76) Inventors: Byungjun Bae, Daejeon (KR); Jinhwan Lee, Daejeon (KR); Joon-Young Choi, Daejeon (KR); Young-Gwon Hahm, Daejeon (KR); Oh-Hyoung Kwon, Daejeon (KR); Chieteuk Ahn, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/284,010

(22) Filed: Oct. 30, 2002

(30) Foreign Application Priority Data
Jul. 22, 2002 (KR) 2002-42931

(51) Int. Cl. H04R 5/00

(52) U.S. Cl. 381/1

(57) ABSTRACT

Disclosed is a contents conversion apparatus which includes; a demultiplexer for demultiplexing an externally input broadcasting stream of a first broadcasting standard and dividing it into an audio stream, a video stream, and a data stream; a converter for converting a coding format of the audio stream to a coding format of a desired second broadcasting standard, and converting a broadcasting service format of the data stream to a service format of the second broadcasting standard; a protocol server for providing a protocol stream of the second broadcasting standard; and a multiplexer for multiplexing the audio stream and the data stream output from the converter, the video stream and the protocol stream to generate one transfer stream.

### BACKGROUND OF THE INVENTION

1. Field of the Invention

The present invention relates to a contents conversion apparatus and method. More specifically, the present invention relates to a contents conversion apparatus and method by which contents of a specific standard can be converted to be used in a digital broadcasting system of a different standard.

2. Description of the Related Art

Recently, broadcasting systems such as for TV have been changed from analog to digital. Satellite, cable, and ground wave broadcasting systems particularly have been digitalized. But the individual broadcasting systems adopt different digital broadcasting standards according to media and service area concerned, and hence, they use different standards for video, audio, protocol, and data streams constituting contents based on the broadcasting standard.

For example, the ATSC (Advanced Television Systems Committee) ground wave broadcasting system adopts MPEG-2 (Moving Picture Experts Group-2) video, AC-3 (Audio Coding-3) PSIP (Program and Systems Information Protocol), and DASE (DTV Application Software Environment) data broadcasting standards. The DVB (Digital Video Broadcasting) ground wave broadcasting system adopts MPEG-2 video, MPEG audio, SI (System Integration) protocol, and MHP (Multimedia Home Platform) data broadcasting standards. The Opencable, American digital cable broadcasting standard adopts MPEG-2 video, AC-3 audio, SI protocol, PSIP protocol for cable, and OCAP (Open Cable Applications Platform) data broadcasting standards.

As stated above, the individual digital broadcasting systems use contents produced according to different standards by service areas. The recent digital broadcasting systems are to use contents produced in the form of stream-based files other than VCE (Video Cassette Recorder) tapes.

Generally, the contents produced in a specific standard cannot be used in a digital broadcasting system that adopts a different standard. To use the contents of a specific standard in a digital broadcasting system of a different standard, an apparatus for converting the contents to be suitable to the desired digital broadcasting standard is needed.

But a contents conversion apparatus between DVB (Digital Video Broadcast) and ATSC broadcasting standards has never been exploited. The only existing contents conversion apparatus is for the conversion between DVB-ASI (DVB-Access Server Integrate) as a DVB transfer bit stream interface standard and SMPTE (Society of Motion Picture and Television Engineers) 310M as an ATSC transfer bit stream interface standard.

Conventionally, for the conversion of contents from one standard to another, the contents are decoded and then coded using the digital broadcasting system of the desired standard. But as the contents are transmitted after being decoded and coded, a deterioration of the broadcasting quality occurs and the data stream has to be reconstructed according to the desired standard.

### SUMMARY OF THE INVENTION

It is an object of the present invention to provide a contents conversion apparatus and method by which contents of a specific standard can be converted to be used in a digital broadcasting system of a different standard.

It is another object of the present invention to convert coded contents to contents of a different standard.

In one aspect of the present invention, there is provided a contents conversion apparatus including: a demultiplexer for demultiplexing an externally input broadcasting stream of a first broadcasting standard and dividing it into an audio stream, a video stream, and a data stream; a converter for converting a coding format of the audio stream to a coding format of a desired second broadcasting standard, and converting a broadcasting service format of the data stream to a service format of the second broadcasting standard; a protocol server for providing a protocol stream of the second broadcasting standard; and a multiplexer for multiplexing the audio stream and the data stream output from the converter, the video stream, and the protocol stream to generate one transfer stream.

The converter includes: a video buffer for delaying the video stream received from the demultiplexer; an audio converter for converting the coding format of the audio stream received from the demultiplexer to a coding format of the second broadcasting standard; a data converter for converting the broadcasting service format of the data stream received from the demultiplexer to a service format of the second broadcasting standard; and a synchronizer for synchronizing the delayed video stream with the converted audio and data streams of the second broadcasting standard.

The audio converter includes: an audio coding type detector for detecting the coding type of the input audio stream; a memory for storing, by audio coding types, audio conversion algorithms for converting the coding format of the audio stream; an audio conversion algorithm controller for determining an algorithm for converting the coding format of the input audio stream to a coding format of the second broadcasting standard using information about the detected coding type of the audio stream; and an audio coding format converter for receiving the determined conversion algorithm from the memory, and converting the coding format of the input audio stream to a coding format of the second broadcasting standard using the received conversion algorithm.

The data converter includes: a data broadcasting service type detector for detecting the broadcasting service type of the input data stream; a memory for storing, by broadcasting service types, conversion algorithms for converting the broadcasting service format of the data stream; a data conversion algorithm controller for determining an algorithm for converting the broadcasting service format of the input data stream to a broadcasting service format of the second broadcasting standard using information about the detected broadcasting service type of the data stream; and a data broadcasting service format converter for receiving the determined conversion algorithm from the memory, and converting the broadcasting service format of the input data stream to a service format of the second broadcasting standard using the received conversion algorithm.

The synchronizer includes: a presentation and decoder time detector for detecting a presentation time and a decoder time of the video stream received from the video buffer, the audio stream from the audio converter, and the data stream from the data converter; and a sub synchronizer for synchronizing the video, audio, and data streams using information about the presentation time and the decoder time.

The converter further includes a sub multiplexer for multiplexing the video, audio, and data streams synchronized by the synchronizer. In this case, the multiplexer multiplexes the multiplexed video, audio, and data streams output from the sub multiplexer and the protocol stream from the protocol server to generate one transfer stream.

In another aspect of the present invention, there is provided a contents conversion method including: (a) demultiplexing an externally input broadcasting stream of a first broadcasting standard and dividing it into an audio stream, a video stream, and a data stream; (b) converting a coding format of the audio stream to a coding format of a desired second broadcasting standard; (c) converting a broadcasting service format of the data stream to a service format of the second broadcasting standard; and (d) multiplexing the video stream, the converted audio and data streams, and a protocol stream corresponding to the second broadcasting standard to generate one transfer stream.

The step (b) includes: detecting the coding type of the input audio stream; determining an algorithm for converting the coding format of the input audio stream to a coding format of the second broadcasting standard using information about the detected coding type of the audio stream; and converting the coding format of the input audio stream to a coding format of the second broadcasting standard using the determined conversion algorithm.

The step (c) includes: detecting the broadcasting service type of the input data stream; determining an algorithm for converting the broadcasting service format of the input data stream to a broadcasting service format of the second broadcasting standard using information about the detected broadcasting service type of the data stream; and converting the broadcasting service format of the input data stream to a service format of the second broadcasting standard using the determined conversion algorithm.

The contents conversion method further includes: (e) delaying the video stream; and (f) synchronizing the delayed video stream with the converted audio and data streams of the second broadcasting standard.

In this case, the step (f) includes: detecting a presentation time and a decoder time of the delayed video stream and the converted audio and data streams;- and synchronizing the video, audio, and data streams using information about the presentation time and the decoder time.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a block diagram of a contents conversion apparatus in accordance with an embodiment of the present invention;

FIG. 2 is a schematic diagram of the converter shown in FIG. 1;

FIG. 3 is a detailed schematic diagram showing the respective components of the converter shown in FIG. 2; and

FIG. 4 is a flow chart showing a contents conversion method in accordance with an embodiment of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

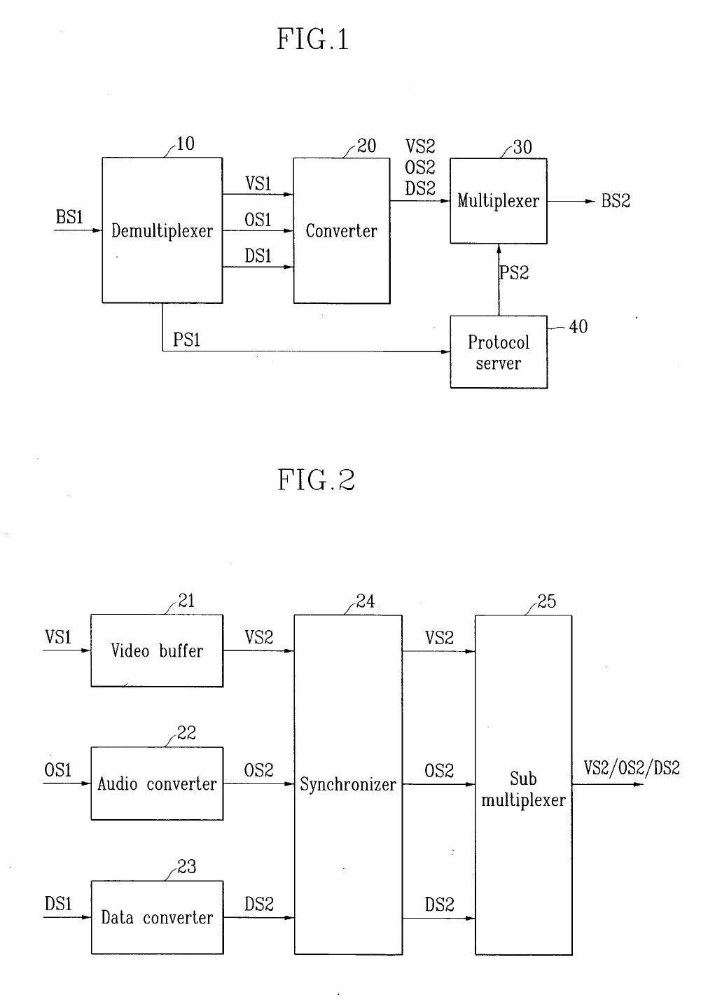

FIG. 1 is a simplified diagram of a contents conversion apparatus in accordance with an embodiment of the present invention.

As illustrated in FIG. 1, the contents conversion apparatus according to the embodiment of the present invention comprises: a demultiplexer 10 for demultiplexing an input digital broadcasting stream BS1 and dividing it into a video stream, an audio stream, a broadcasting protocol stream, and a data stream; a converter 20 for converting the divided streams to streams of a desired broadcasting standard; a multiplexer 30 for multiplexing the converted streams of the broadcasting standard and a broadcasting protocol stream corresponding to the broadcasting standard to generate one transfer stream BS2; and a protocol server 40 for sending the broadcasting protocol stream corresponding to the broadcasting standard to the multiplexer 30.

The digital broadcasting stream BS1 as contents according to the embodiment of the present invention comprises, if not specifically limited to, video stream VS1, audio stream OS1, data stream DS1, and broadcasting protocol stream PS1. The video stream generally meets the same standard in every broadcasting system. Hence, the rest of the streams, i.e., audio, data, and broadcasting protocol streams are converted in this embodiment, which is not intended to limit the scope of the present invention.

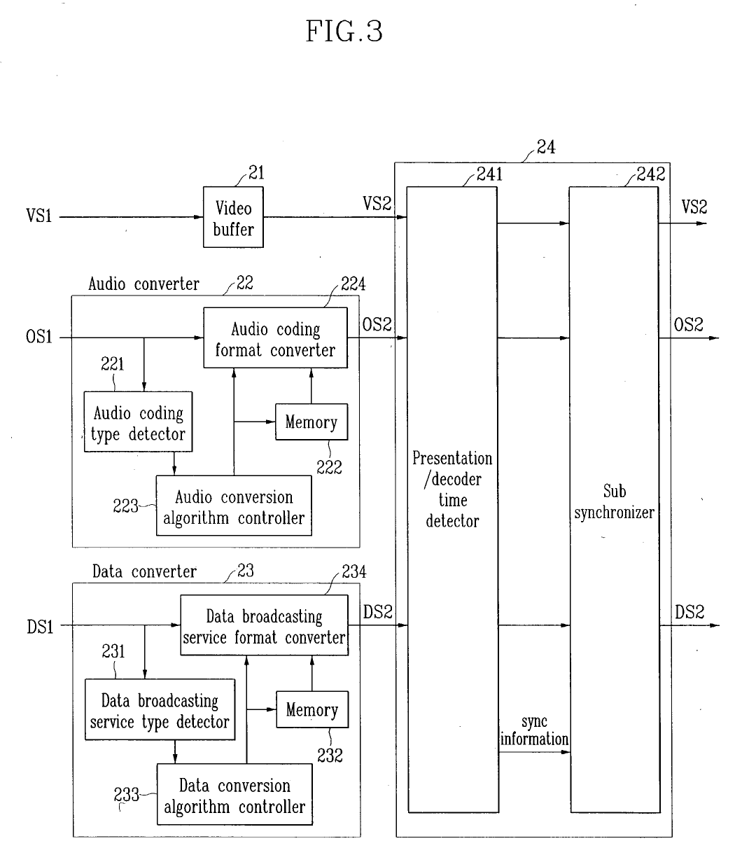

FIG. 2 is a schematic diagram of the converter shown in FIG. 1, and FIG. 3 is a detailed schematic diagram of the converter.

Referring to the schematic diagram of the converter 20, as illustrated in FIG. 2, the converter 20 comprises a video buffer 21, an audio converter 22, a data converter 23, a synchronizer 24, and a sub multiplexer 25.

The video buffer 21 delays a video stream VS1 received from the demultiplexer 10 and sends the delayed video stream VS1 to the synchronizer 24.

The audio converter 22 converts an audio stream OS1 received from the demultiplexer 10 to an audio stream OS2 defined in a desired standard for broadcasting (hereinafter referred to as “broadcasting standard”). The data converter 23 converts a data stream DS1 to a data stream DS2 of the broadcasting standard.

The audio converter 22 and the data converter 23, which convert the input audio and data streams OS1 and DS1 according to the broadcasting standard, respectively comprise, as shown in FIG. 3, type detectors 221 and 231, memories 222 and 232, controllers 223 and 233, and format converters 224 and 234.

More specifically, the audio converter 22 comprises: the audio coding type detector 221 for detecting the coding type of the input audio stream OS1; the memory 222 for storing, by audio coding types, audio conversion algorithms for converting the coding format of the audio stream to a coding format of the broadcasting standard; the audio conversion algorithm controller 223 for determining an algorithm for converting the coding format of the input audio stream to a coding format of the broadcasting standard using information about the detected coding type of the audio stream; and the audio coding format converter 224 for receiving the determined conversion algorithm of the audio conversion algorithm controller 223 from the memory 222, and converting the coding format of the input audio stream OS1 to a coding format of the broadcasting standard using the conversion algorithm received.

The data converter 23 comprises: the data broadcasting service type detector 231 for detecting the broadcasting service type of the input data stream DS1; the memory 232 for storing, by broadcasting service types, conversion algorithms for converting the broadcasting service format of the data stream to a service format of the broadcasting standard; the data conversion algorithm controller 233 for determining an algorithm for converting the broadcasting service format of the input data stream DS1 to a broadcasting service format of the broadcasting standard using information about the detected broadcasting service type of the data stream; and the data broadcasting service format converter 234 for receiving the determined conversion algorithm of the data conversion algorithm controller 233 from the memory 232, and converting the broadcasting service format of the input data stream DS1 to a broadcasting service format of the broadcasting standard using the conversion algorithm received.

The synchronizer 24 synchronizes the video stream VS2 delayed by the video buffer 21 with the converted audio and data streams OS2 and DS2 of the broadcasting standard, and then outputs the synchronized video, audio, and data streams VS2, OS2, and DS2.

More specifically, the synchronizer 24 comprises, as shown in FIG. 3, a presentation/decoder time detector (hereinafter, referred to as “time detector”) 241 for detecting the respective presentation/decoder times of the video stream VS2 received from the video buffer 21, the audio stream OS2 from the audio converter 22, and the data stream DS2 from the data converter 23; and a sub synchronizer 242 for synchronizing the video, audio, and data streams VS2, OS2, and DS2 using presentation/decoder time information.

The sub multiplexer 25 of the converter 20 multiplexes the video, audio, and data streams VS2, OS2, and DS2 synchronized by the above-constructed synchronizer 24.

The multiplexer 30 multiplexes the video, audio, and data streams VS2, OS2, and DS2 multiplexed from the converter 20, and an input protocol stream PS2, to generate one transfer stream BS2.

The protocol server 40 stores the protocol stream PS2 of the broadcasting standard and provides it to the multiplexer 30 at an appropriate time.

Now, the operation of the contents conversion apparatus according to an embodiment of the present invention will be described.

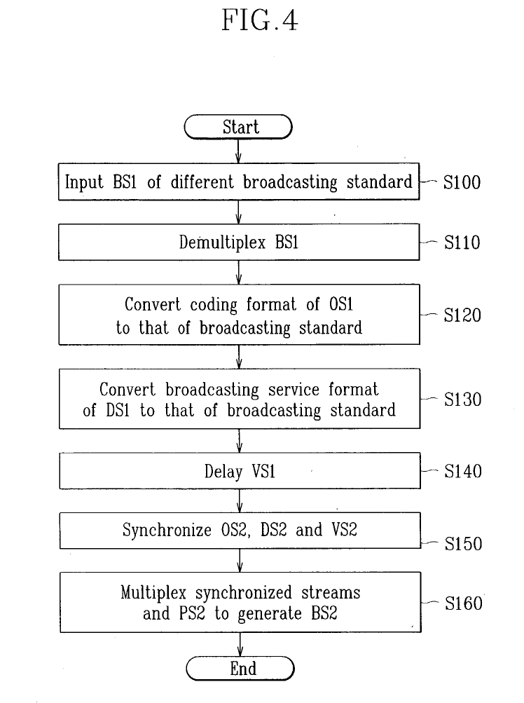

FIG. 4 is a flow chart showing a contents conversion method in accordance with the embodiment of the present invention.

One broadcasting system (not shown) sends a coded broadcasting stream BS1 of a specific standard, in step 100. The demultiplexer 10 demultiplexes the broadcasting stream BS1 to generate a video stream VS1, an audio stream OS1, a data stream DS1, and a broadcasting protocol stream PS1, in step 110.

The video, audio, and data streams VS1, OS1, and DS1 are input to the video buffer 21, the audio converter 22, and the data converter 23 of the converter 20, respectively. The broadcasting protocol stream PS1 is sent to the protocol server 40, which passes over the input broadcasting stream PS1 and sends a broadcasting protocol stream PS2 of a desired broadcasting standard to the multiplexer 30.

The audio converter 22 and the data converter 23 convert the audio stream OS1 and the video stream VS1 to meet the broadcasting standard, and the video buffer 21 delays the input video stream VS1 for synchronization of the converted audio and video streams OS1 and VS1, in steps 120, 130, and 140.

More specifically, the audio coding type detector 221 of the audio converter 22 detects the coding type of the input audio stream. Generally, information about the coding type of the audio/video stream is recorded in a specific field of the broadcasting protocol PSIP/PSI/SI. So the audio coding type detector 221 reads out the audio coding type information from the field to detect the coding type of the audio stream and sends it to the audio conversion algorithm controller 223.

The audio conversion algorithm controller 223 determines a conversion algorithm for converting the coding format of the input audio stream to a coding format of the broadcasting standard using the audio coding type information, and commands the memory 222 to send the audio conversion algorithm to the audio coding format converter 224.

Accordingly, the memory 222 sends the corresponding audio conversion algorithm to the audio coding format converter 224, which then converts the coding format of the audio stream OS1 received from the demultiplexer 10 to a coding format of the broadcasting standard using the received conversion algorithm.

As described above, the coded audio stream OS1 is converted to a coding format according to the broadcasting standard without being decoded and therefore a deterioration of the transmission quality hardly occurs in transmission of the audio stream.

In the data converter 23, the data broadcasting service type detector 231 detects the broadcasting service type of the input data stream DS1 and sends the detected broadcasting service type information to the data conversion algorithm controller 233. The data conversion algorithm controller 233 determines a conversion algorithm for converting the broadcasting service format of the input data stream to a broadcasting service format of the broadcasting standard using the broadcasting service type information, and commands the memory 232 to send the determined data conversion algorithm to the data broadcasting service format converter 234.

Accordingly, the memory 232 sends the corresponding data conversion algorithm to the data broadcasting service format converter 234, which then converts the broadcasting service format of the data stream DS1 received from the demultiplexer 10 to a broadcasting service format of the broadcasting standard using the conversion algorithm received.

As described above, the data stream OS1 produced in a specific standard is converted to a service format of a second broadcasting standard without separate data stream processing, making the conversion of the data stream easier and faster.

As stated above, the audio and data streams OS2 and DS2 converted to meet the broadcasting standard are input to the synchronizer 24, and the video stream VS2 delayed by the video buffer 21 is also input to the synchronizer 24.

The time detector 241 of the synchronizer 24 detects the presentation/decoder time of the video, audio, and data streams VS2, OS2, and DS2, and the sub synchronizer 242 synchronizes the video, audio, and data streams VS2, OS2, and DS2 using the detected presentation/decoder time information, in step 150.

More specifically, video signals take a much longer time in compression and restoration than audio signals in the compression and transmission of video and audio signals, so that auditory-visual discordance occurs at the receiver. To solve this problem, the header of the PES (Packetized Elementary Stream) of each signal stores a DTS (Decoding Time Stamp) as decoder time information for designating a decoding time at the receiver, and a PTS (Presentation Time Stamp) as presentation time information for designating an output (representation) time after the decoding of the signals at the receiver. The time detector 241 reads out the DTS and PTS values from the header of each signal and presents the decoder/presentation time as a difference between the DTS/PTS value and reference time information, i.e., a PCR (Program Clock Reference). The sub synchronizer 242 synchronizes the video, audio, and data streams VS2, OS2, and DS2 using the decoder time and the presentation time of each signal that are presented according to the PCR and bear a mutual relation.

Each of the synchronized video, audio, and data streams VS2, OS2, and DS2 is then multiplexed by the sub multiplexer 25.

Then the multiplexer 30 multiplexes the multiplexed video, audio, and data streams VS2, OS2, and DS2 output from the converter 20 and the protocol stream PS2 of the broadcasting standard from the protocol server to generate one transfer stream BS2, in step 160.

Subsequently, the transfer stream BS2 produced in the broadcasting standard is transmitted via a transmitter of the broadcasting system (not shown).

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

According to the embodiment of the present invention, contents (e.g., video, audio, data, etc.) of a specific standard can be readily converted to be used in a digital broadcasting system of a different standard.

Particularly, contents of a specific standard are converted to contents of a different standard without a decoding process, so that they can be shared without a deterioration of the broadcasting quality.

What is claimed is:

1. A contents conversion apparatus comprising:
a demultiplexer for demultiplexing an externally input broadcasting stream of a first broadcasting standard and dividing it into an audio stream, a video stream, and a data stream;
a converter for converting a coding format of the audio stream to a coding format of a desired second broadcasting standard, and converting a broadcasting service format of the data stream to a service format of the second broadcasting standard;
a protocol server for providing a protocol stream of the second broadcasting standard; and
a multiplexer for multiplexing the audio stream and the data stream output from the converter, the video stream and the protocol stream to generate one transfer stream.

2. The contents conversion apparatus as claimed in claim 1, wherein the converter comprises:
a video buffer for delaying the video stream received from the demultiplexer;
an audio converter for converting the coding format of the audio stream received from the demultiplexer to a coding format of the second broadcasting standard;
a data converter for converting the broadcasting service format of the data stream received from the demultiplexer to a service format of the second broadcasting standard; and
a synchronizer for synchronizing the delayed video stream with the converted audio and data streams of the second broadcasting standard.

3. The contents conversion apparatus as claimed in claim 2, wherein the audio converter comprises:
an audio coding type detector for detecting the coding type of the input audio stream;
a memory for storing, by audio coding types, audio conversion algorithms for converting the coding format of the audio stream;
an audio conversion algorithm controller for determining an algorithm for converting the coding format of the input audio stream to a coding format of the second broadcasting standard using information about the detected coding type of the audio stream; and
an audio coding format converter for receiving the determined conversion algorithm from the memory, and converting the coding format of the input audio stream to a coding format of the second broadcasting standard using the conversion algorithm received.

4. The contents conversion apparatus as claimed in claim 2, wherein the data converter comprises:
a data broadcasting service type detector for detecting the broadcasting service type of the input data stream;
a memory for storing, by broadcasting service types, conversion algorithms for converting the broadcasting service format of the data stream;
a data conversion algorithm controller for determining an algorithm for converting the broadcasting service format of the input data stream to a broadcasting service format of the second broadcasting standard using information about the detected broadcasting service type of the data stream; and
a data broadcasting service format converter for receiving the determined conversion algorithm from the memory, and converting the broadcasting service format of the input data stream to a service format of the second broadcasting standard using the conversion algorithm received.

5. The contents conversion apparatus as claimed in claim 2, wherein the synchronizer comprises:
a presentation and decoder time detector for detecting a presentation time and a decoder time of the video stream received from the video buffer, the audio stream from the audio converter, and the data stream from the data converter; and
a sub synchronizer for synchronizing the video stream, the audio stream, and the data stream using information about the presentation time and the decoder time.

6. The contents conversion apparatus as claimed in claim 2, wherein the converter further comprises:
a sub multiplexer for multiplexing the video stream, the audio stream, and the data stream synchronized by the synchronizer.

7. The contents conversion apparatus as claimed in claim 6, wherein the multiplexer multiplexes the multiplexed video stream, the audio stream, and the data stream output from the sub multiplexer and the protocol stream from the protocol server to generate one transfer stream.

8. A contents conversion method comprising:
(a) demultiplexing an externally input broadcasting stream of a first broadcasting standard and dividing it into an audio stream, a video stream, and a data stream;
(b) converting a coding format of the audio stream to a coding format of a desired second broadcasting standard;
(c) converting a broadcasting service format of the data stream to a service format of the second broadcasting standard; and
(d) multiplexing the video stream, the converted audio and data streams, and a protocol stream corresponding to the second broadcasting standard to generate one transfer stream.

9. The contents conversion method as claimed in claim 8, wherein the step (b) comprises:
detecting the coding type of the input audio stream;
determining an algorithm for converting the coding format of the input audio stream to a coding format of the second broadcasting standard using information about the detected coding type of the audio stream; and
converting the coding format of the input audio stream to a coding format of the second broadcasting standard using the determined conversion algorithm.

10. The contents conversion method as claimed in claim 8, wherein the step (c) comprises:
detecting the broadcasting service type of the input data stream;
determining an algorithm for converting the broadcasting service format of the input data stream to a broadcasting service format of the second broadcasting standard using information about the detected broadcasting service type of the data stream; and
converting the broadcasting service format of the input data stream to a service format of the second broadcasting standard using the determined conversion algorithm.

11. The contents conversion method as claimed in claim 8, further comprising:
(e) delaying the video stream; and
(f) synchronizing the delayed video stream with the converted audio and data streams of the second broadcasting standard.

12. The contents conversion method as claimed in claim 9, wherein the step (f) comprises:
detecting a presentation time and a decoder time of the delayed video stream and the converted audio and data streams; and
synchronizing the video, audio, and data streams using information about the presentation time and the decoder time.
